(19) United States
(12) Patent Application Publication
(10) Pub. No.: US 2009/0070688 A1
(43) Pub. Date: Mar. 12, 2009

(54) METHOD AND APPARATUS FOR MANAGING INTERACTIONS

(75) Inventors: Julius S. Gyorfi, Vernon Hills, IL (US); Eric R. Buhrke, Clarendon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/851,514

(22) Filed: Sep. 7, 2007

(51) Int. Cl. G06F 3/048; G10L 15/26

(52) U.S. Cl. 715/758; 704/235

(57) ABSTRACT

A method and apparatus for managing interactions between participants of a shared virtual environment is disclosed. The method comprises establishing a communication session by a first participant of the shared virtual environment with a second participant of the shared virtual environment. A data stream is received by the first participant located at a first location from the second participant located at a second location. Using the received data stream, a view of the shared virtual environment for the first participant is generated. An audio of the received data stream is controlled by the first participant. A text of the controlled audio is generated and the generated text is displayed in the view of the shared virtual environment of the first participant.

### FIELD OF THE DISCLOSURE

The present disclosure relates generally to the field of shared virtual environments, and more particularly to managing interactions between participants of the shared virtual environment.

### BACKGROUND

Various virtual environments are known in the art. Such environments typically serve to permit a group of participants who share a similar interest, goal, or task to interact with one another. Because of the shared similarities, such an environment is generally referred to as a shared virtual environment. Participants in a shared virtual environment are generally represented by an avatar. A participant viewing the shared virtual environment will typically see, within the shared virtual environment, one or more avatars that represent the other participants that are present in the shared virtual environment. The participants interact with each other in the shared virtual environment.

The shared virtual environment allows participants to have audio interactions, to have visual interactions, to share documents, and so forth. In the shared virtual environment, a situation may arise where all the participants interact with each other at the same time. In such a case, the shared virtual environment may then look chaotic, sound noisy, and/or be unpleasant. Where two participants are having audio interactions with each other, the audio interactions may disturb the other participants having other interactions (audio or otherwise) in the shared virtual environment.

Accordingly, there is a need for a method and apparatus for managing interactions.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram illustrating an environment where various embodiments of the present invention may be practiced;

FIG. 2 is a block diagram illustrating an apparatus for managing interactions between participants of a shared virtual environment;

FIG. 3 is a block diagram illustrating elements of a processing unit, in accordance with some embodiments of the present invention;

FIG. 4 is a flowchart illustrating a method for managing interactions between participants of a shared virtual environment; and

FIG. 5a illustrates a display unit, in accordance with an embodiment of the present invention.

FIG. 5b illustrates a display unit, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention provide a method and an apparatus for managing interactions between participants of a shared virtual environment. A communication session is established by a first participant of the shared virtual environment with a second participant of the shared virtual environment. In the shared virtual environment, the first participant is represented as a first avatar and the second participant is represented as a second avatar. A data stream is received by the first participant located at a first location from the second participant located at a second location. Using the received data stream, a view of the shared virtual environment is generated for the first participant so that the shared virtual environment comprises the second avatar where the second avatar represents the second participant as seen from a perspective of the first participant. The audio of the data stream of the second participant is controlled by the first participant. A text of the controlled audio is generated and displayed in the view of the shared virtual environment of the first participant.

Before describing in detail the method and apparatus for managing interactions between participants of a shared virtual environment, it should be observed that the present invention resides primarily in combinations of method steps and system components related to a method and apparatus for managing interactions. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

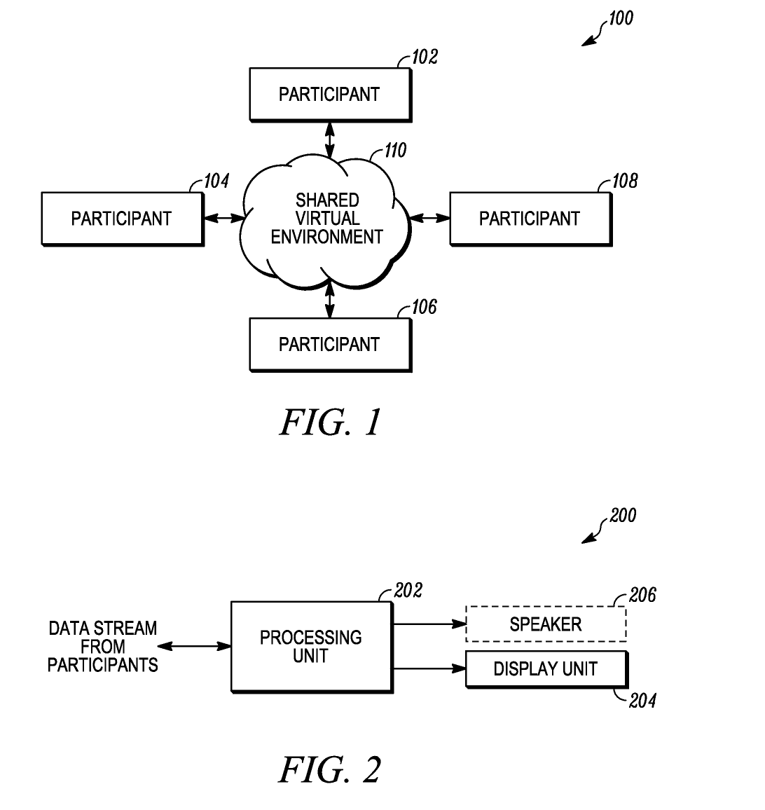

FIG. 1 is a block diagram illustrating an environment 100 where various embodiments of the present invention may be practiced. The environment 100 includes a shared virtual environment 110, a first participant 102, a second participant 104, a third participant 106, and a fourth participant 108. The first participant 102 of the shared virtual environment establishes a communication session with the second participant 104 of the shared virtual environment. The communication session is established by connecting the first participant to a shared virtual environment server (not shown) to which the second participant 104 is also connected. The first participant 102 and the second participant 104 can then exchange messages to enable the communication session. In one example, the messages that are exchanged between the first participant 102 and the second participant 104 include authentication messages. The authentication messages are exchanged in order to authenticate the participants (102-108) of the shared virtual environment 110.

The shared virtual environment server may reside on a network such as an Internet, a Public Switched Telephone Network (PSTN), a mobile network, a broadband network, and so forth. In accordance with various embodiments of the invention, the shared virtual environment 110 can also reside on a combination of different types of networks. Thus, the use of the term “network” is meant to encompass all such variants.

Once the communication session is established, the participants (102-108) communicate by transmitting and receiving data streams across the network. Each of the data streams can be an audio stream, an audio data stream, a video stream or an audio-visual data stream, as is generally known.

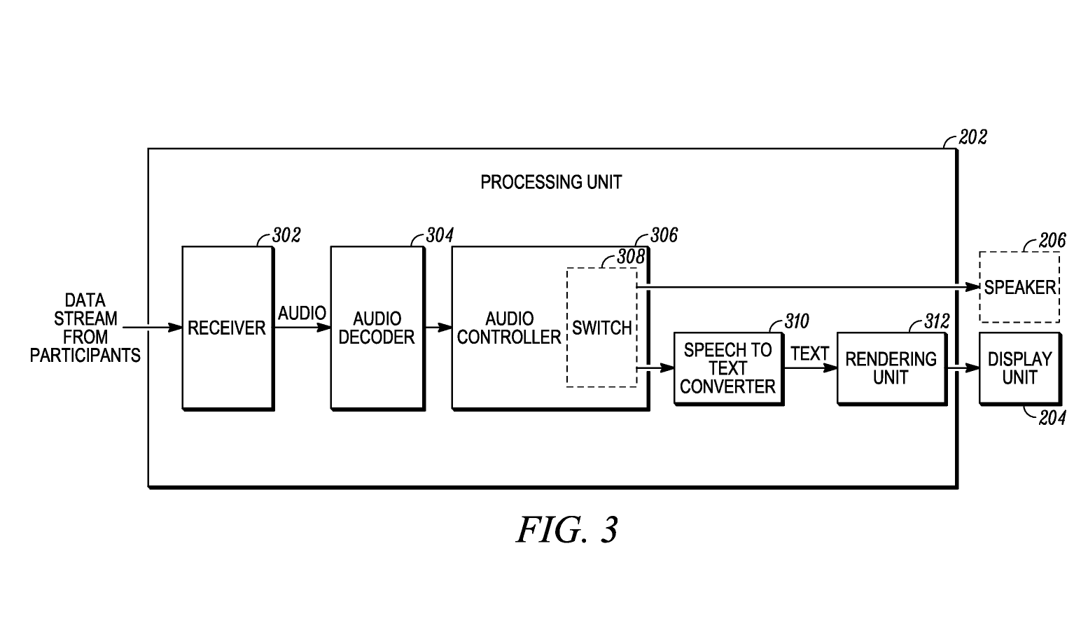

FIG. 2 is a block diagram illustrating an apparatus 200 for managing interactions between participants (102-108) of a shared virtual environment 110. The apparatus 200 is associated with each participant in the shared virtual environment, e.g., participants 102-108 of FIG. 1. As such, each apparatus 200 for each participant is capable of establishing a communication session and performing communications in the shared virtual environment. The apparatus 200 includes a processing unit 202 coupled to a display unit 204. Optionally, the apparatus includes a speaker 206. In an embodiment, the apparatus 200 may be realized in an electronic device. Examples of the electronic device are a computer, a Personal Digital Assistant (PDA), a mobile phone, and so forth. The electronic device includes the processing unit 202 coupled to the display unit 204 and optionally the speaker 206.

The display unit 204 receives processed data from the processing unit and displays an avatar of each of the participants (102-108) of the shared virtual environment 110. The avatars correspond to virtual representations of participants of the shared virtual environment 1 10. Examples of virtual representation are an image, animation, a video, audio, or any combination of these examples. As such, an avatar of the second participant 104 may be a video received from the second participant 104 or an avatar of the second participant may be an image (e.g., a drawing, picture, shape, etc.) in combination with audio received from the second participant.

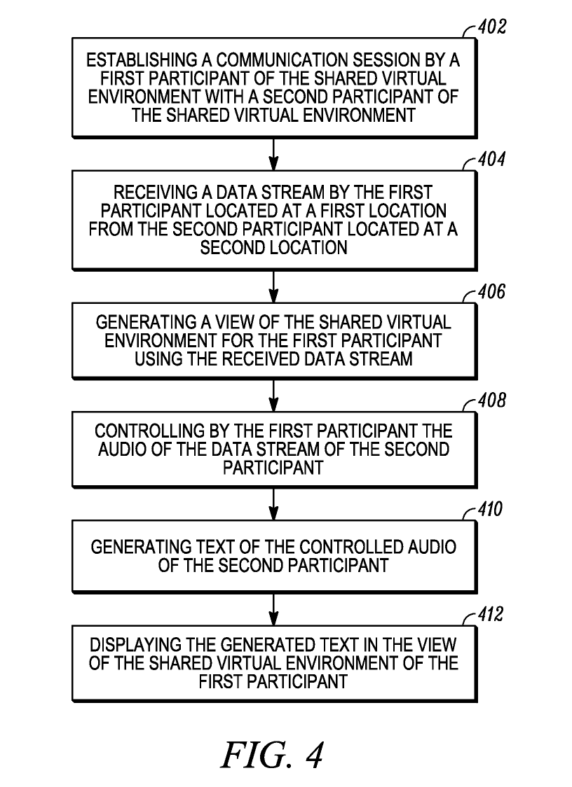

FIG. 3 is a block diagram illustrating the elements of the processing unit 202, in accordance with an embodiment of the invention. The processing unit 202 includes a receiver 302, an audio decoder 304, an audio controller 306, a speech to text converter 310, and a rendering unit 3 12. The receiver 302 receives a data stream from a participant (e.g., second participant 104) of the shared virtual environment 1 10. The audio decoder 304 decodes audio from the received data stream. The data stream can include audio, video, still images, visualizations, slide shows, and/or any combination. The audio controller 306 controls the decoded audio, e.g., of the second participant 104.

In an embodiment, the audio controller 306 includes a switch 308. The switch 308 operates to enable the decoded audio of the second participant to be controlled. As an example, the decoded audio will be controlled by the audio controller 306 when the switch 308 is in an active state. When the switch 308 is in an inactive state, which is normally the case, the decoded audio will be sent to the speaker 206 of the apparatus 200, e.g., associated with second participant 104.

The speech to text converter 310 coupled to the audio controller 306 generates text of the audio being controlled. The text is generated by converting the controlled audio of the second participant 104 into text, e.g., using any well known speech recognition algorithm or transcription service.

The rendering unit 312 generates a view of the shared virtual environment 502, e.g., by a process called rendering. As is known, rendering is a process of generating an image from a description of three dimensional objects. Typically, description includes geometry, viewpoint, texture, lighting, and shading information for the three dimensional objects. In an embodiment, the rendering unit 312 generates the view of the shared virtual environment 502 for the first participant 102 by generating images of the other participants' (namely 104-108) avatars and objects in the shared virtual environment. Specifically, the view of the shared virtual environment 502 has a surface upon which the avatar of the second participant is rendered. In one embodiment, the view of the shared virtual environment 502 is generated using the data stream received from the second participant 104. In any case, the rendering unit 312 coupled to the speech to text converter 310 then displays the text received from the speech to text converter 310 in the view of the shared virtual environment 502.

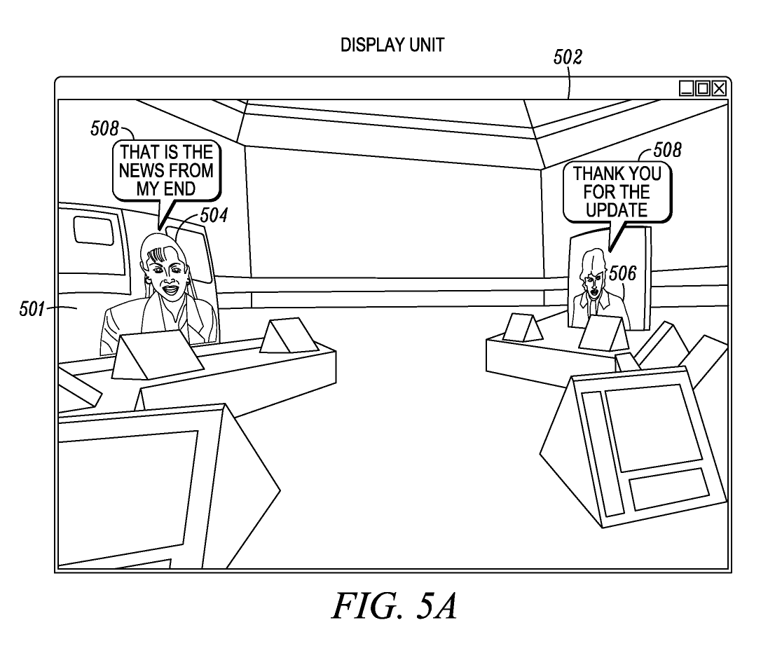

FIG. 4 is a flowchart illustrating a method for managing interactions between participants (102-108) of a shared virtual environment 110, in accordance with an embodiment of the present invention. At step 402, a communication session is established by the first participant 102 with the second participant 104 of the shared virtual environment 110. In one example, establishing the communication session occurs by connecting the first participant to a shared virtual environment server to which the second participant is connected and exchanging authentication messages between the first participant and the second participant to enable the communication session.

At step 404, a data stream is received by the first participant 102 from the second participant 104. As mentioned above, the data stream can include audio, video, still images, visualizations, slide shows, and/or any combination. In an embodiment, the first participant 102 is located at a first location and the second participant 104 is located at a second location. In such an embodiment, the second location may be remote to the first location.

At step 406, a view of the shared virtual environment 502 for the first participant 102 is generated using the data stream received from the second participant 104. The view of the shared virtual environment 502 includes the second avatar 504 as seen from a perspective of the first participant 102. In an embodiment, generating the view of the shared virtual environment 502 is implemented by selecting a surface 501 within the view of the shared virtual environment 502 and rendering the second avatar 504 on the selected surface 501.

The surface 501 (also referred to as a “texture”) is defined as any surface that can be drawn upon in a virtual environment or an application user interface of the apparatus 200. As such, the texture may be, e.g., a Java Mobile 3D Graphics (“M3G”) texture, a Java Abstract Window Toolkit (“AWT”) image, a 3D virtual environment drawable surface, a 2D drawable surface, or a user interface element. Once the view of the shared virtual environment 502 is generated, the participants (102-108) of the shared virtual environment 110 begin interacting with each other. The interactions are facilitated by the sending and receiving of data streams among the participants (102-108).

At step 408, the audio of the data stream of the second participant 104 is controlled by the first participant 102. In one example, if the first participant 102 has sufficient authority, the first participant 102 will be able to control the audio of the second participant 104. In any case, in an embodiment, controlling the decoded audio of the second participant 104 is done in a number of ways. One way is by muting the audio (namely the decoded audio) where muting the audio of the second participant 104 means to silence the audio of the second participant 104. In another way, controlling the decoded audio of the second participant 104 is done by varying the volume of the audio. In an example, the volume of the audio of the second participant 104 is changed, e.g., lowered. In yet another way, controlling the decoded audio of the second participant 104 means to make the audio of the second participant 104 audible.

Upon controlling the audio of the second participant 104, a text of the audio of the second participant 104 is generated at step 410. At step 412, the generated text is displayed in the view of the shared virtual environment 502 of the first participant 102. In an embodiment, the method of displaying the generated text is performed by locating a region in the view of the shared virtual environment 502 and then displaying the generated text as an overlay in the located region. Displaying the generated text as an overlay is done by superimposing the generated text on the located region. In an example, locating a region in the view of the shared virtual environment 502 means to find a region in the view of the shared virtual environment that pertains to the second avatar 504.

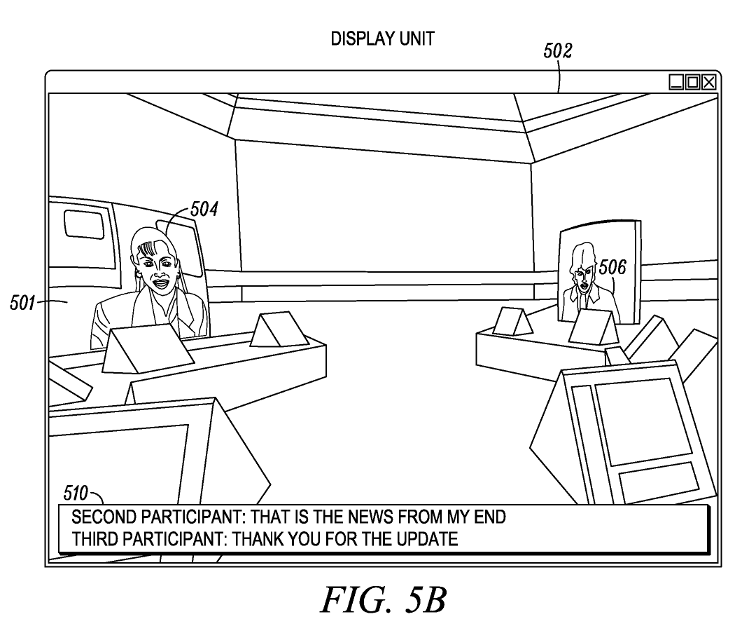

In an alternate embodiment, as shown in FIG. 5a, the method of displaying the generated text is performed by creating a new surface 508 in the view of the shared virtual environment 502 proximate to the second avatar 504 and rendering the generated text on the new surface 508. The term proximate here means to be at a close distance to the second avatar 504 such that the displayed text appears to be originating from the second avatar 504. In yet another embodiment, as shown in FIG. 5b, the generated text is rendered within a two-dimensional text field 510 within the view of the shared virtual environment 502 of the first participant 102. The source of the generated text is then indicated to the first participant 102 in the two-dimensional text field 510.

In an example embodiment, the shared virtual environment includes the third participant 106. Accordingly, a communication session is established by the first participant 102 with the third participant 106 of the shared virtual environment 1 10. The first participant 102 is located at a first location and the third participant 106 is located at a third location. A data stream is received by the first participant 102 from the third participant 106. A view of the shared virtual environment 502 for the first participant 102 is generated using the data stream received from the third participant 106. The view of the shared virtual environment 502 includes the third avatar 506 as seen from a perspective of the first participant 102. The third avatar 506 represents the third participant 106. The audio of the data stream of the third participant 106 is controlled by the first participant 102. The text of the controlled audio of the third participant 106 is displayed in the view of the shared virtual environment 502 of the first participant 102.

In another embodiment, one of the participants of the shared virtual environment 110 behaves as a controller while the rest of the participants of the shared virtual environment 110 behave as controllees. The controller may be the participant having sufficient authority to control the interactions of the controllees. The controller is also given authority to authenticate the controllees trying to establish communication sessions. In this embodiment, the controller is located at a first location and the controllee is located at a second location. The second location is remote to the first location. The controller and the controllee are represented as avatars. The controller receives data streams from the controllee in real-time. Receiving data in real-time means to acquire data as and when it is being generated and transmitted as opposed to receiving recorded data for later playback. In real-time, delay is limited to the actual time required to transmit the data. Using the received real-time data stream, a view of the shared virtual environment is generated for the controller. The view of the shared virtual environment includes an avatar of the controllee as seen from a perspective of the controller. On controlling the audio of the controllee by the controller, a text of the controlled audio is generated. The generated text is then displayed in the view of the shared virtual environment of the controller.

FIGS. 5A and 5B illustrate a display unit (e.g., 204) in accordance with embodiments of the present invention. The display unit shown in FIGS. 5a and 5b displays a view of the shared virtual environment 502 from the view of a first participant (e.g., 102). The view of the shared virtual environment 502 includes an avatar (second avatar 504) of a second participant (e.g., 104) and an avatar (third avatar 506) of a third participant (e.g., 106). The second avatar 504 represents the second participant as seen from a perspective of the first participant. The third avatar 506 represents the third participant as seen from a perspective of the first participant. As shown in FIGS. 5A and 5B, when viewing the shared virtual environment (e.g., 110) from the perspective of the first participant, the second avatar 504 and third avatar 506 now become visible in the field of view. Those skilled in the art will also understand and appreciate that the various avatars, objects, and other elements of the shared virtual environment are viewed as seen from the perspective of each avatar so as to ensure that the view of each avatar comprises a unique and appropriate view that accords with the respective position and orientation of the participant (e.g., the first participant) that is viewing the shared virtual environment. In any case, as mentioned previously, the difference between the display units shown in FIGS. 5A and 5B is the location of the generated text, e.g., in FIG. 5A, the generated text is displayed in surfaces 508 and in FIG. 5B, the generated text is displayed in two-dimensional text field 510.

Regardless of the display of the generated text, examples of embodiments of the present invention provide for managing interactions. In an example, the shared virtual environment represents a public safety environment in which members of police department and Federal Bureau of Investigation (FBI) may be present as participants of the shared virtual environment. In use, a marshal (e.g., a first participant) may enter the shared virtual environment to see avatars of the local chief of police (e.g., a second participant) and a regional head of the FBI (e.g., a third participant). The chief of police and the regional head of the FBI are engaged in a loud argument on who has jurisdiction on a case. This acrimonious exchange is so overwhelming that the marshal mutes the audio of the chief of police and the audio of the regional head of the FBI. As the avatars of the chief of police and the regional head of the FBI go silent, a text of the argument between the chief of police and the regional head of the FBI appears overlaid on their respective avatars. A participant of the shared virtual environment will thus be able to follow and keep up with the silenced interactions as well as the interactions between other participants in the shared virtual environment. The participant then has the advantage of being able to manage interactions.

In this document, relational terms such as first and second, top and bottom, and the like may be used solely to distinguish one entity or action from another entity or action without necessarily requiring or implying any actual such relationship or order between such entities or actions. The above description and the diagrams do not necessarily require the order illustrated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. As such, these functions may be interpreted as steps of a method. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for managing interactions between participants of a shared virtual environment, the method comprising:
establishing a communication session by a first participant of the shared virtual environment with a second participant of the shared virtual environment, wherein in the shared virtual environment the first participant is represented as a first avatar and the second participant is represented as a second avatar;
receiving a data stream by the first participant located at a first location from the second participant located at a second location;
generating a view of the shared virtual environment for the first participant using the received data stream, wherein the view of the shared virtual environment comprises the second avatar and wherein the second avatar represents the second participant as seen from a perspective of the first participant;
controlling by the first participant audio of the data stream of the second participant;
generating text of the controlled audio of the second participant; and
displaying the generated text in the view of the shared virtual environment of the first participant.

2. The method of claim 1, wherein establishing the communication session by the first participant with the second participant of the shared virtual environment comprises:
connecting the first participant to a shared virtual environment server to which the second participant is connected; and
exchanging messages between the first participant and the second participant to enable the communication session.

3. The method of claim 1, wherein generating the view of the shared virtual environment comprises:
selecting a surface within the view of the shared virtual environment upon which the second avatar can be rendered; and
rendering the second avatar on the selected surface.

4. The method of claim 1, wherein displaying the generated text comprises:
locating a region in the view of the shared virtual environment; and
displaying the generated text as an overlay in the located region.

5. The method of claim 1, wherein displaying the generated text comprises:
creating a new surface in the view of the shared virtual environment proximate to the second avatar; and
rendering the generated text on the new surface.

6. The method of claim 1, wherein displaying the generated text comprises:
rendering the generated text within a two-dimensional text field within the view of the shared virtual environment of the first participant; and
indicating the source of the generated text as the second participant.

7. The method of claim 1, wherein generating the text of the controlled audio comprises converting the controlled audio into text.

8. The method of claim 1, wherein controlling audio of the data stream comprises muting the audio.

9. The method of claim 1, wherein controlling audio of the data stream comprises varying a volume of the audio.

10. The method of claim 1, wherein controlling audio comprises making audio audible.

11. The method of claim 1, wherein the data stream comprises audio and at least one of video, still images, visualizations, slide shows, or any combination thereof.

12. The method of claim 1, further comprising:
establishing a communication session by the first participant of the shared virtual environment with a third participant of the shared virtual environment, wherein in the shared virtual environment the third participant is represented as a third avatar;
receiving the data stream by the first participant located at the first location from the third participant located at a third location;
generating the view of the shared virtual environment for the first participant using the received data stream, wherein the view of the shared virtual environment comprises the third avatar and wherein the third avatar represents the third participant as seen from the perspective of the first participant;
controlling by the first participant audio of the data stream of the third participant;
generating text of the controlled audio of the third participant; and
displaying the generated text in the view of the shared virtual environment of the first participant.

13. A method for managing interactions between participants of a shared virtual environment, the method comprising:
establishing a communication session between the participants of the shared virtual environment, wherein the participants include a controller at a first location and a controllee at a second location and wherein the controller and the controllee are represented as avatars in the shared virtual environment;
receiving a real-time data stream by the controller from the controllee;
generating a view of the shared virtual environment for the controller using the received real-time data stream, wherein the view of the shared virtual environment comprises an avatar of the controllee and wherein the avatar of the controllee represents the controllee as seen from a perspective of the controller;
controlling by the controller audio of the received real-time data stream;
generating text of the controlled audio of the controllee; and
displaying the generated text in the view of the shared virtual environment of the controller.

14. A system for managing interactions between participants of a shared virtual environment, the system comprising: at a first participant:
a display unit for displaying a view of the shared virtual environment for the first participant, wherein the view of the shared virtual environment comprises an avatar of a second participant of the shared virtual environment; and
a processing unit coupled to the display unit for processing a data stream received from the second participant, wherein the processing unit comprises,
a receiver for receiving the data stream from the second participant,
an audio decoder for decoding audio of the received data stream,
an audio controller for controlling the decoded audio of the second participant,
a speech to text converter for generating text of the audio being controlled, and
a rendering unit for generating the view of the shared virtual environment by using the received data stream and for displaying the generated text in the view of the shared virtual environment.

15. The system of claim 14, wherein the avatar of the second participant is a virtual representation comprising at least one of an animated avatar, a video avatar, or an audio avatar.

16. The system of claim 14, wherein the view of the shared virtual environment further comprises a surface upon which the avatar of the second participant is rendered.

17. The system of claim 14, wherein the data stream comprises the audio and at least one of video, still images, visualizations, slide shows, or any combination thereof.

18. The system of claim 14, wherein the audio controller further comprises a switch for enabling the decoded audio of the second participant to be controlled.

19. The system of claim 18, wherein the switch further enables the decoded audio of the second participant to be sent to a speaker.

20. The system of claim 14, wherein the speech to text converter converts the audio of the second participant to text using a speech recognition algorithm.
